(19) United States
(12) Patent Application Publication
(10) Pub. No.: US 2008/0191444 A1
(43) Pub. Date: Aug. 14, 2008

(54) Motorcycle rear wheel trim assembly

(76) Inventors: Alwin J. Stahel, St. Paul, MN (US); Brian K. Stahel, St. Paul, MN (US)

Correspondence Address: John M. Weyrauch;DICKE, BILLIG & CZAJA, PLLC, Suite 2250, 100 South Fifth Street, Minneapolis, MN, 55402, US

(21) Appl. No.: 11/703,877

(22) Filed: Feb. 8, 2007

(51) Int. Cl. B62D 25/18; B60R 13/04

(52) U.S. Cl. 280/154

(57) ABSTRACT

A motorcycle rear wheel trim assembly, for mounting relative to a motorcycle rear wheel assembly, comprises a trim piece having an upper edge and a curved lower edge. A first mounting bracket is connected to the trim piece at a first end of the trim piece, and a second mounting bracket is attached to a second end of the trim piece. The first mounting bracket is configured to be connected to a first location on a first stationary structural member of a motorcycle adjacent to a rear wheel assembly of the motorcycle. The second mounting bracket is configured to be connected to a second location on a second stationary structural member of the motorcycle adjacent to the rear wheel assembly of the motorcycle. The first and second locations are selected to center the trim piece relative to a drive hub of the rear wheel assembly, with the upper edge of the trim piece positioned below a longitudinal axis defined by a swing arm of the motorcycle, and the lower edge of the trim piece generally adjacent to wheel rim of the rear wheel assembly.

### BACKGROUND

The present invention generally relates to custom accessories for a motorcycle, and more particularly, to a rear wheel trim accessory for a motorcycle.

### SUMMARY OF THE INVENTION

The present invention comprises a method of mounting a trim piece relative to a lower portion of a motorcycle rear wheel assembly having a swing arm, a drive hub, a wheel mounted relative to the drive hub and a tire mounted to the wheel. The method comprises providing a planar member having a first end, a second end, an upper edge and a curved lower edge. The curved lower edge of the planar member is connected to the upper edge. The method further comprises securing a first mounting bracket to a first end of the trim piece, the first mounting bracket having a mounting surface spaced from the upper edge, and further securing a second mounting bracket to a second end of the trim piece, the second mounting bracket having a mounting surface spaced from the upper edge. The method comprises further connecting the mounting surface of the first mounting bracket to a first location on a first stationary structural member of the motorcycle adjacent to the motorcycle rear wheel assembly, and connecting the mounting surface of the second mounting bracket to a second location, spaced from the first location, on a second stationary structural member of the motorcycle adjacent to the motorcycle rear wheel assembly. The steps of connecting the first and second mounting brackets locate the upper edge of the trim piece below a longitudinal axis defined by the swing arm.

### BRIEF DESCRIPTION OF THE DRAWINGS

FIG. 1 is a side view of a rear end of a motorcycle showing a rear wheel trim assembly of the present invention mounted adjacent to a rear wheel assembly of the motorcycle;

FIG. 2 is a front perspective view of one embodiment of a mounting frame for the rear wheel trim assembly shown in FIG. 1;

FIG. 3 is a front perspective view of a trim piece of the rear wheel trim assembly shown in FIG. 1;

FIG. 4 is a rear perspective view of the trim piece of FIG. 3;

FIG. 5 is a perspective view of a first threaded adaptor stud used for mounting a first end of the rear wheel trim assembly according to one embodiment of the present invention;

FIG. 6 is a perspective view of a second threaded adaptor stud used for mounting a second end of the rear wheel trim assembly according to one embodiment of the present invention.

### DETAILED DESCRIPTION

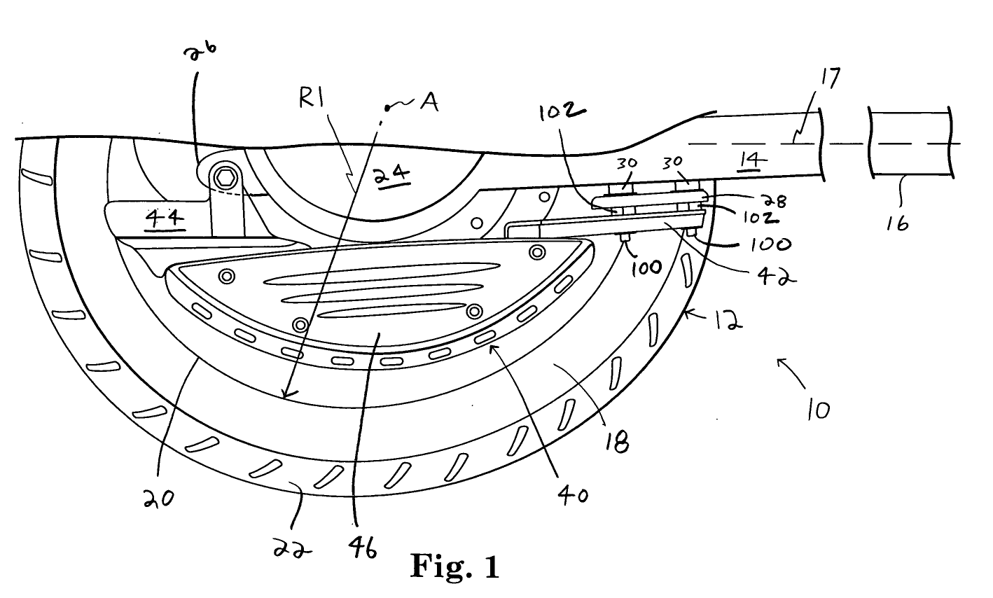

FIG. 1 is a side view of a motorcycle rear end 10 of a motorcycle, e.g., a Honda Gold Wing® motorcycle, illustrating a rear wheel assembly 12 coupled to a swing arm 14 that extends from a motorcycle frame 16 along a longitudinal axis 17. Rear wheel assembly 12 includes a wheel 18 having a rim 20 and a tire 22 mounted to the rim 20. Wheel 18 is operatively coupled to a drive hub 24 carried at the end of swing arm 14. Associated with rear wheel assembly 12 near drive hub 24 is a rear caliper mount shown generally at 26 for bolting a rear caliper (not shown) to drive hub 24. In general, rim 20 defines a radius R1 extending from a center axis A of drive hub 22, drive hub 22 being generally axially located relative to rim 20. As further shown in FIG. 1, swing arm 14 includes a vibration damper 28 which is typically bolted to a pair of spaced mounts 30 at a lower extent of swing arm 14 adjacent to drive hub 24.

The present invention is a motorcycle rear wheel trim assembly 40 that is mountable relative to rear wheel assembly 12. In general, in one exemplary embodiment rear wheel trim assembly 40 comprises a first mounting bracket 42 that is mountable to mounts 30 on the swing arm 14, a second mounting bracket 44 that is mountable to the rear caliper mount 26, and a trim piece 46 supported between mounting bracket portions 42, 44. Mounting brackets 42, 44 are configured to position the trim piece 46 at a lower extent of rear wheel assembly 12 that is visible to an observer.

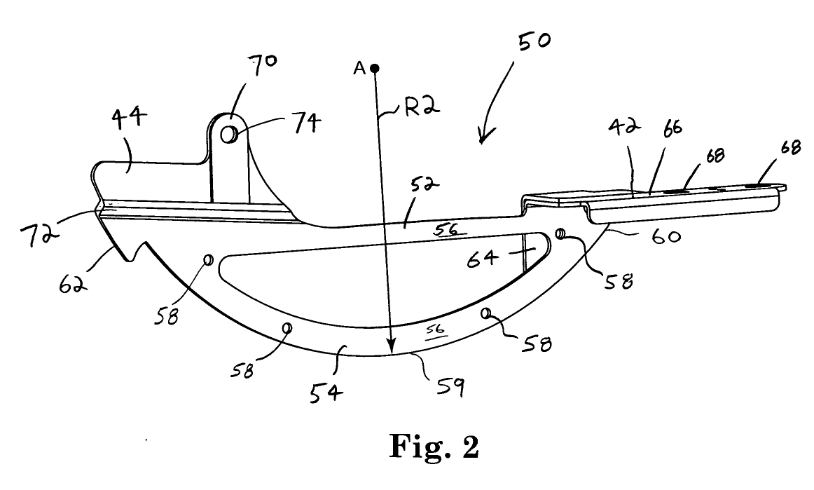

FIG. 2 is a front perspective view of one exemplary embodiment of a frame 50 for mounting trim piece 46 relative to the rear wheel assembly 12. Frame 50 is a unitary frame comprising an upper linear frame member 52 and a lower curved frame member 54. As shown in FIG. 2, the curved frame member 54 is provided with a plurality of spaced mounting holes 58 adjacent to a lower edge 59 of the curved frame member 54. The upper and lower frame members 52, 54 define a planar mounting surface 56 for attaching the trim piece 46 with connectors to holes 58.

In one embodiment, first mounting bracket 42 is associated with end 60 of frame 50, and second mounting bracket 44 is associated with an opposite end 62 of frame 50. The first mounting bracket 42 comprises a unitary metal bracket having a first planar portion 64 connected to frame 50 in plane common with the upper and lower frame members 52, 54, and a second planar portion 66 that extends generally normal to the first planar portion 64. The second planar portion 66 includes a pair of mounting holes 68. The first mounting bracket 42 is configured to permit holes 68 to align with and connect to mounts 30 on swing arm 14 so as to orient frame 50 in a plane generally common with the rear wheel assembly 12.

Second mounting bracket 44 is integral with upper frame member 52 and extends from upper frame member 52 in a direction opposite the lower frame member 54. Second mounting bracket 44 includes a mounting tab 70 in a plane generally common with the upper and lower frame members 52, 54, and a transverse wall 72 connected to the upper frame member 52. Mounting tab 70 includes a hole 74. In one embodiment, the second mounting bracket 44 is configured to permit hole 74 to align with the caliper mount 26 when the first mounting bracket 42 is secured to swing arm 14 so as to maintain frame 50 in a plane generally common with the rear wheel assembly 12. Collectively frame 50 and mounting brackets 42 and 44 are configured for connection to a stationary structural member of a motorcycle adjacent to a rear wheel assembly 12 such that the upper frame member 52 is below and spaced from the longitudinal axis 17 of the swing arm 14 and the lower frame member 54 is radially spaced generally at a radius R2 relative to drive hub 24 (FIG. 1). In one embodiment R2 is selected to be generally the same as R1 to position a lower edge of trim piece 46 near rim 20. Other configurations of frame 50 and mounting brackets 42 and 44 are also possible according to the particular radial spacing desired for the lower extent of rear wheel trim assembly 40. Frame 50 and mounting brackets 42 and 44 may be fabricated from plate metal, e.g., by stamping. Mounting bracket 42 may be formed integrally with frame 50 or formed as a separate bracket assembly that is secured to frame 50, such as by welding.

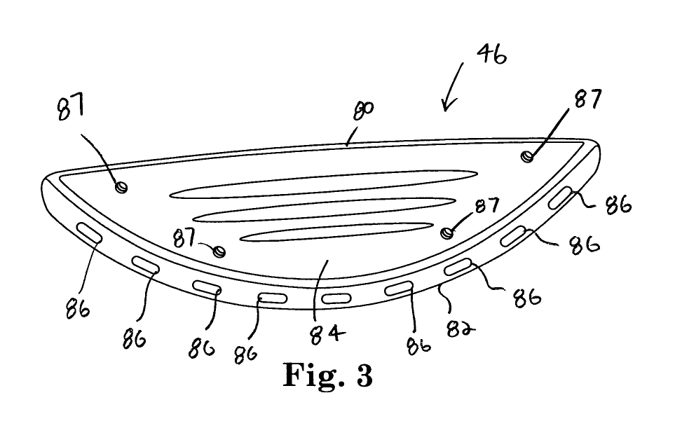

FIG. 3 is a front perspective view of one embodiment of trim piece 46. Trim piece 46 generally comprises a generally hemispherical plate having an upper generally linear edge 80, a lower curved edge 82, an outer surface 84 and a plurality of windows 86 radially spaced along outer surface 84 adjacent to the lower curved edge 82. Trim piece 46 is configured with a plurality of holes 87 that are oriented to align with holes 58 of frame 50.

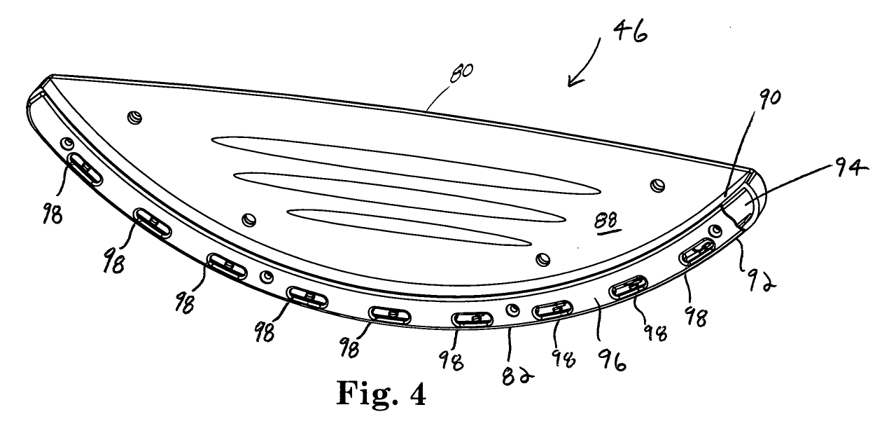

FIG. 4 is a rear perspective view of trim piece 46. As shown in FIG. 4, in one embodiment, trim piece 46 comprises a rear surface 88 and a pair of spaced curved walls 90 and 92 that are connected to and extend generally normal from the rear surface 88 to define a cavity 94 adjacent to the lower curved edge 82. Cavity 94 is configured to receive an LED light strip 96 having a plurality of LED lights 98 that align with the windows 86 of trim piece 46 (FIG. 3). LED light strip 96 includes mounting holes that align with associated mounts within cavity 94 for securing light strip 96 to trim piece 46 with suitable connectors. LED light strip 96 includes a wire harness (not shown) for electrically connecting light strip 96 to an electrical system of the motorcycle. Curved wall 90 further defines a surface that registers with the lower edge 59 of curved frame member 54. Trim piece 46 is secured to frame 50 via holes 87, 58 with suitable connectors, the upper edge 80 of trim piece 46 thereby being generally adjacent to the upper frame member 52 of frame 50.

In one embodiment, trim piece 46 is fabricated from a durable plastic and includes chrome plating on all exterior surfaces. In one embodiment, trim piece 46 is injection molded from a plastic and has a wall thickness of about 0.031 inches.

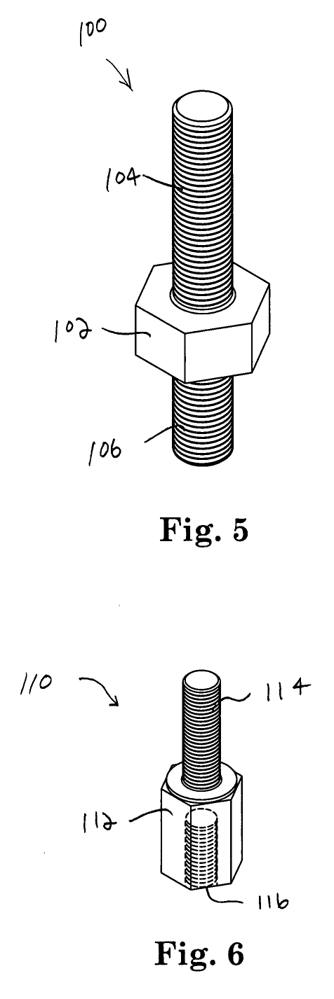

FIG. 5 is a perspective view of an adaptor stud 100 configured for coupling first mounting bracket 42 to a first suitable stationary structural member of a motorcycle, e.g., swing arm 30. In one embodiment, adaptor stud 100 includes a hex body 102, a first externally threaded post 104 extending from hex body 102 in a first direction, and a second externally threaded post 106 extending from hex body 102 in a second, opposite direction.

Referring to FIG. 1, in one embodiment, to mount rear wheel assembly 12, factory bolts holding the vibration damper 28 relative to mounts 30 are removed. Threaded post 104 is sized and configured to mate with mounts 30. The threaded post 104 of adaptor stud 100 is then threaded within each mount 30 and secured with an amount of torque factory recommended to connect the vibration damper 28 to swing arm 14. Holes 68 of mounting bracket 42 are aligned with the threaded posts 106 of each adaptor stud 100 and mounting bracket 42 is secured to each adaptor stud 100 with a suitable connector, such as a lock washer and a nut.

FIG. 6 is a perspective view of an adaptor stud 110 configured for coupling second mounting bracket 44 to a second suitable stationary structural member of a motorcycle, e.g., the caliper mount 26 (FIG. 1). In one embodiment, adaptor stud 110 includes a hex body 112 and an externally threaded post 114 extending from a first end of hex body 112. Hex body 112 further includes an internally threaded bore 116 that extends within body 112 from a second opposite end of body 112. The threaded post 114 is sized and configured to replace a factory bolt that engages the caliper mount 26 to secure a portion of the rear caliper to the drive hub 24. To install the second mounting bracket 44 according to one embodiment, the factory bolt in caliper mount 26 is removed and replaced with adaptor stud 110, with threaded post 114 threaded within caliper mount 26. The second mounting bracket 44 is positioned with hole 74 of tab 70 aligned with the internally threaded bore 116 of adaptor stud 110. The second mounting bracket 44 is thereafter secured by a suitable connector, such as a bolt, that threads into the internally threaded bore 116 of adaptor stud 110. With the first and second mounting brackets 42, 44 so connected, trim piece 46 is oriented to be generally centered relative to drive hub 24 of wheel assembly 12 with the upper edge 80 of trim piece 46 spaced below the longitudinal axis 17 of the swing arm 14, and lower edge 82 radially spaced from the drive hub 24 sufficiently such that trim piece 46 is laterally visible when the motorcycle is in use. In one embodiment, the lower edge 82 of trim piece 46 will be located at a radial spacing R2 relative to drive hub 24 that is generally equal to the radial spacing R1 of the wheel rim 20 relative to drive hub 24. Further, trim piece 46 is supported by mounting brackets 42, 44 so as to be in a plane spaced from and generally parallel to rear wheel assembly 12.

Although specific embodiments have been illustrated and described herein, it will be appreciated by those of ordinary skill in the art that a variety of alternate and/or equivalent implementations of the present invention may be substituted for the specific embodiments shown and described without departing from the scope of the present invention. While the specific embodiment disclosed contemplates the use of existing mounting structures on the swing arm 14 for mounting a rear wheel trim assembly 40, it is intended that other trim piece configurations and mounting structures may be used to mount a rear wheel trim assembly according to the present invention. As such, trim piece 46 and frame 50 may be incorporated into a single structure without departing from the scope of the present invention. In addition, mounting brackets 42, 44 may be configured to connect to mounting sites on the swing arm 14 and/or drive hub 24 created by modifications to those components. In addition, other mount sites for a rear wheel trim assembly can be created by attaching mounts relative to one or more of the stationery motorcycle structures located relative to the rear wheel assembly, such as the swing arm, the drive hub, the rear saddle bag, the exhaust pipe, etc., via welding, clamping, or other attachment technique. This application is intended to cover any such adaptations or variations of rear wheel trim assemblies beyond the specific embodiments discussed herein. Therefore, it is intended that this invention be limited only by the claims and the equivalents thereof.

What is claimed is:

1. A motorcycle rear wheel trim assembly for a motorcycle rear wheel assembly, the rear wheel trim assembly comprising:
a trim piece comprising a planar member having a linear upper edge and a curved lower edge, the curved lower edge connected to the upper edge, the curved edge having an apex spaced from the linear upper edge, the trim piece further having a first end and a second end;
a first mounting bracket secured to the trim piece, the first mounting bracket having a first mounting surface spaced from the upper edge generally adjacent to the first end of the trim piece, the first mounting surface of the first mounting bracket configured for connection to a first stationary structural member of a motorcycle adjacent to the rear wheel assembly of the motorcycle;
a second mounting bracket secured to the trim piece, the second mounting bracket having a second mounting surface spaced from the upper edge generally adjacent to the second end of the trim piece, the second mounting bracket configured for connection to a second stationary structural member of the motorcycle adjacent to the motorcycle rear wheel assembly.

2. A method of mounting a trim piece relative to a lower portion of a motorcycle rear wheel assembly having a swing arm, a drive hub, a wheel mounted relative to the drive hub and a tire mounted to the wheel, the method comprising:
providing a trim piece comprising a planar member having an upper edge and a curved lower edge, the curved lower edge connected to the upper edge, the trim piece further having a first end and a second end;
securing a first mounting bracket to a first end of the trim piece, the first mounting bracket having a mounting surface spaced from the upper edge;
securing a second mounting bracket to a second end of the trim piece, the second mounting bracket having a mounting surface spaced from the upper edge;
connecting the mounting surface of the first mounting bracket to a first location on a first stationary structural member of the motorcycle adjacent to the motorcycle rear wheel assembly;
connecting the mounting surface of the second mounting bracket to a second location on a second stationary structural member of the motorcycle adjacent to the motorcycle rear wheel assembly, the first location being spaced from the second location, whereby the steps of connecting the first and second mounting brackets locates the upper edge of the trim piece below a longitudinal axis defined by the swing arm.
